(19) United States
(12) Patent Application Publication
(10) Pub. No.: US 2013/0070753 A1
(43) Pub. Date: Mar. 21, 2013

(54) CONSISTENT UPDATES FOR PACKET CLASSIFICATION DEVICES

(71) Applicants: Sartaj Sahni, Gainesville, FL (US); Tania Mishra, Gainesville, FL (US)

(72) Inventors: Sartaj Sahni, Gainesville, FL (US); Tania Mishra, Gainesville, FL (US)

(73) Assignee: UNIVERSITY OF FLORIDA RESEARCH FOUNDATION, INC., Gainesville, FL (US)

(21) Appl. No.: 13/699,424

(22) PCT Filed: May 25, 2011
(86) PCT No.: PCT/US11/37925

§ 371 Date: Nov. 21, 2012

Related U.S. Application Data
(60) Provisional application No. 61/348,339, filed on May 26, 2010.

(51) Int. Cl. H04L 12/56

(52) U.S. Cl. CPC H04L 45/021
USPC 370/351

(57) ABSTRACT

A method for managing incremental classifier tables is disclosed. A sequence of classifier table updates is received. Each update in the sequence of updates is associated with a filter and is analyzed. If multiple updates are received at the same time, then all updates associated with the same filter are identified. The updates on the same filter can be reduced to a single update resulting in an identical final state of the same filter. The other updates associated with the filter are removed from the sequence of updates. A reduced sequence of classifier updates is generated based on other updates of filters with multiple updates being removed. The reduced sequence of classifier updates comprises a set of classifier table updates, where for each distinct filter in the reduced sequence only one update is associated therewith. A reordered sequence of update operations is generated from the reduced sequence of update operations.

### CROSS-REFERENCE TO RELATED APPLICATIONS

This application is based upon and claims priority to U.S. Provisional Patent Application Ser. No. 61/348,339 filed May 26, 2010 the disclosure of which is hereby incorporated by reference in its entirety.

### STATEMENT REGARDING FEDERALLY SPONSORED RESEARCH

This invention was made with Government support under Contract No.: 13300 UConn Subgrant to NSF Project #00073123. The Government may have certain rights in this invention.

### FIELD OF THE INVENTION

The present invention generally relates to the field of network devices, and more particularly relates to packet classification device updates.

### BACKGROUND OF THE INVENTION

The Internet is a large collection of autonomous systems (AS) around the world, where the autonomous systems are interconnected by the huge Internet backbone network comprising of high capacity data routes and packet classification devices, such as routers. An autonomous system (AS) is in itself a collection of networks and packet classification devices, such as routers, under a single administrative control. Examples of AS include networks in companies, universities, and ISPs. As a packet moves from source to destination, the packet passes a number of routers in its path. Each packet classification device forwards the packet to the appropriate output from which the packet resumes its journey to the next packet classification device. Packet classification devices at the border of an AS exchange reachability information (for prefixes within the AS and those outside the AS and reachable through the AS) with border packet classification devices of other autonomous systems.

The Internet uses Border Gateway Protocol (BGP) for inter-AS routing. BGP is essentially an incremental protocol in which a packet classification device, such as a router, generates update packets/messages only when there is a change in its routing state. An Internet packet classification device may receive a batch of tens of thousands of BGP updates (insert a new rule or delete/change an existing rule) in any instant (i.e., with the same timestamp). Generally, these updates can either be applied incrementally, i.e., one at a time, or as a batch, i.e., at the same time. However, current methods that apply these update packets incrementally usually apply the updates in the order that they were received. This is an inefficient method and can lead to consistency issues. Current methods that apply these updates using a batch method usually result in an out-of-date table since updates are not applied when they are received, instead they are applied in batches at various time intervals. Another problem with the current updating methods is that redundant updates are not efficiently handled.

### SUMMARY OF THE INVENTION

In one embodiment, a method for managing classifier tables is disclosed. A sequence of classifier table updates is received. Each update in the sequence of updates is associated with a filter. Each update in the sequence of updates is analyzed. If multiple updates are received at the same time, then all updates associated with the same filter are identified based on analyzing the updates that were received at the same time. The updates on the same filter can be reduced to a single update resulting in an identical final state of the same filter. The other updates associated with the filter are removed from the sequence of updates. A reduced sequence of classifier updates is generated based on the other updates of filters with multiple updates being removed. The reduced sequence of classifier updates comprises a set of classifier table updates where for each distinct filter in the reduced sequence only one update is associated which specifies a given final state of the distinct filter. A reordered sequence of update operations is generated from the reduced sequence of update operations.

In another embodiment, an information processing system for managing classifier tables is disclosed. The information processing system comprises a memory and a processor that is communicatively coupled to the memory. An update manager is communicatively coupled to the memory and the processor. The update manager is configured to perform a method comprises receiving a sequence of classifier table updates. Each update in the sequence of updates is analyzed. If multiple updates are received at the same time, then all updates associated with the same filter are identified based on analyzing the updates that were received at the same time. The updates on the same filter can be reduced to a single update resulting in an identical final state of the same filter. The other updates associated with the filter are removed from the sequence of updates. A reduced sequence of classifier updates is generated based on the other updates of filters with multiple updates being removed. The reduced sequence of classifier updates comprises a set of classifier table updates where for each distinct filter in the reduced sequence only one update is associated which specifies a given final state of the distinct filter. A reordered sequence of update operations is generated from the reduced sequence of update operations.

In yet another embodiment, a computer program product for managing classifier tables is disclosed. The computer program product comprises computer readable storage medium having computer readable program code embodied therewith. The computer readable program code comprises computer readable program code configured to perform a method. The method comprises receiving sequence of classifier table updates. Each update in the sequence of updates is analyzed. If multiple updates are received at the same time, then all updates associated with the same filter are identified based on analyzing the updates that were received at the same time. The updates on the same filter can be reduced to a single update resulting in an identical final state of the same filter. The other updates associated with the filter are removed from the sequence of updates. A reduced sequence of classifier updates is generated based on the other updates of filters with multiple updates being removed. The reduced sequence of classifier updates comprises a set of classifier table updates where for each distinct filter in the reduced sequence only one update is associated which specifies a given final state of the distinct filter. A reordered sequence of update operations is generated from the reduced sequence of update operations.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one operating environment according to one embodiment of the present invention;

FIG. 2 is illustrates prefixes in a forwarding table before updates are applied;

FIG. 3 is illustrates prefixes in a forwarding table after updates are applied;

FIG. 4 illustrates batch consistent updates according to one embodiment of the present invention;

FIG. 5 illustrates an example of batch consistency violation according to one embodiment of the present invention;

FIG. 6 illustrates one example of an update sequence according to one embodiment of the present invention;

FIG. 7 illustrates a reduced update sequence according to one embodiment of the present invention;

FIG. 8 illustrates one example of performing a forwarding table update according to one embodiment of the present invention;

FIG. 9 illustrates an example of a reduced update sequence that can produce intermediate forwarding tables of different sizes;

FIG. 10 illustrates a sequence U of m/2 deletes followed by m/2 inserts according to one embodiment of the present invention;

FIG. 11 illustrates one example of a reduced update set V and its corresponding digraph G according to one embodiment of the present invention;

FIG. 12 shows one example of an algorithm that determines a near-optimal topological order according to one embodiment of the present invention;

FIG. 13 illustrates one example of a digraph for which sub-optimal ordering is produced;

FIG. 14 illustrates one example of a delete star according to one embodiment of the present invention;

FIG. 15 illustrates examples of complex digraph components of trace update data according to one embodiment of the present invention;

FIG. 16 shows various datasets used in experiments of one or more embodiments of the present invention;

FIG. 17 shows examples of synthetic classifiers and update traces used in of one or more embodiments of the present invention;

FIG. 18 shows the total number of update operations that remain after applying the reduction technique of various embodiments to each update batch;

FIG. 19 shows a maximum increase in intermediate classifier rule table size after applying the heuristic of FIG. 12 for every x updates in the experiments of one or more embodiments of the present invention;

FIG. 20 is an operational flow diagram illustrating one example of a process for creating a consistent sequence of updates according to one embodiment of the present invention;

FIG. 21 is an operational flow diagram illustrating one example of a process for managing classifier tables according to one embodiment of the present invention; and

FIG. 22 shows one example of an information processing system according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and other similar terms as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

### Operating Environment

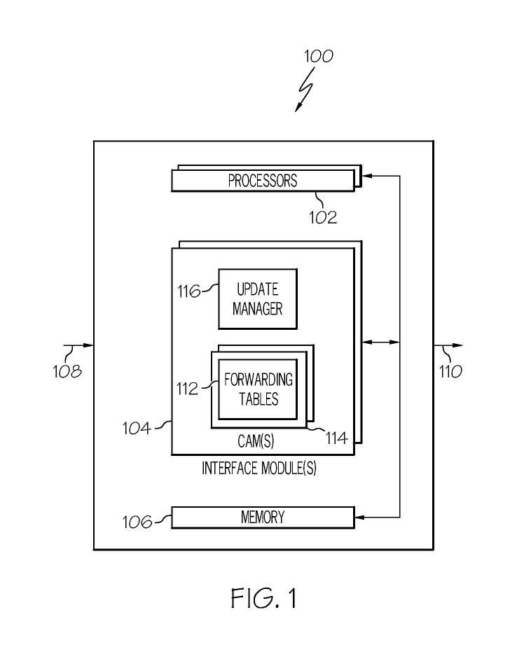

According to one embodiment of the present invention, as shown in FIG. 1, a network device 100 such as a packet classification device is shown. It should be noted throughout the following discussion, an Internet router is used as a non-limiting example of a packet classification device. As will be discussed in greater detail below the network device 100 comprises a system that optimally reduces the number of operations in an update batch. The system orders the updates in the optimally reduced set so as to guarantee batch or incremental consistency (depending on which type of consistency is desired) when the updates are done one by one in the generated order. Further, the system applies heuristics to minimize the maximum size of an intermediate table. The output of the system can then be provided to any packet classification device that supports incremental updates. When this packet classification device performs the updates in the provided order, table consistency is maintained.

The network device 100 comprises one or more processors 102, one or more interface modules 104, and one or more memories 106. The network device 100 also comprises one or more input lines 108 through which packets are input and one or more output lines 110. The interface module 104 receives a packet and determines the next hop to forward this packet based on one or more forwarding tables 112. In one embodiment, the forwarding table 112 is stored within a content addressable memory (CAM) 114. The CAM can be a kernel-based CAM, a ternary CAM, or the like. The interface module 104 then transmits the packet to the determined next hop via the output line(s) 110.

In one embodiment, the network device 110 receives packets such as, but not limited to, update packets/messages from another network device. These update packets/messages, which in one example are BGP updates, can instruct the network device 100 to insert a new rule or delete/change an existing rule in the forwarding table 112. However, the network device 100 can receive a batch of tens of thousands of these packets with the same time stamp. Therefore, the network device 100 comprises an update manager 116 that manages these update packets. For example, as will be discussed in greater detail below, the update manager 116 analyzes possible orderings of a batch of updates such that classifier table consistency is maintained while these updates are performed one at a time as in a table that supports incremental updates rather than batch updates. The update manager 116 also removes any redundancies in the batch or updates and uses one or more heuristics to arrange the reduced set of updates into a consistent sequence that results in a near minimal increase in table size as the updates are performed one by one. The embodiments discussed further below can be performed by the update manager 116.

### Overview

Internet packets can be classified into different flows based on the packet header fields. This classification of packets can be performed using a table of rules in which each rule is of the form (F,A), where F is a filter and A is an action. When an incoming packet matches a filter in the classifier, the corresponding action determines how the packet is handled. For example, the packet could be forwarded to an appropriate output link, or it may be dropped. A d-dimensional filter F is a d-tuple (F[1], F[2], . . . , R[d]), where F[i] is a range specified for an attribute in the packet header, such as destination address, source address, port number, protocol type, TCP flag, etc. A packet matches filter F, if its attribute values fall in the ranges of F[1], . . . , F[d]. Since it is possible for a packet to match more than one of the filters in a classifier thereby resulting in a tie, each rule has an associated priority. When a packet matches two or more filters, the action corresponding to the matching rule with the highest priority is applied on the packet (it is assumed that filters that match the same packet have different priorities).

A packet forwarding table is a 1-dimensional packet classification device, where the filter is a destination prefix and the action is to forward a packet to a next hop which is a router output link. Therefore, each forwarding table rule is also represented as (P,H), where P is a prefix and H is the next hop for forwarding a packet whose destination address matches P. If a destination address matches multiple rules, then the rule with the longest matching prefix (LMP) is used to select the next hop. Accordingly, in case of packet forwarding, the set of matching rules is implicitly prioritized based on the length of the prefixes, where the matching rule with the longest prefix is assigned the highest priority.

The set of rules in a packet classification device is constantly changing over time with new rules being added and existing rules being changed or deleted. In the following discussion, the functions insert, delete and change are used to represent the insertion, deletion and change, respectively, of a rule in a packet classification device. Typically, a cluster of update messages gets ready to be processed by a router at the same time. For example, if one considers update messages received by a router under Border Gateway Protocol (BGP) from a BGP update file, multiple route announcement and withdrawal notices can be seen in the same message, and many such messages having the same timestamp of receipt. The announcement and withdrawal messages result in insertion, deletion or changes in rules in the forwarding table of the router. The updates received in a cluster can be processed either incrementally, or in a batch. Most routers perform updates one at a time (i.e., incrementally) in the control plane concurrent with lookup operations in the data plane. By incrementally performing the updates in a cluster in a carefully selected order, it is possible for an incrementally updated router to behave exactly like one that is batch updated. Note that in a batch updated router, packets are routed to a next hop determined either by the rule table before any update is done or by the rule table following the incorporation of all updates.

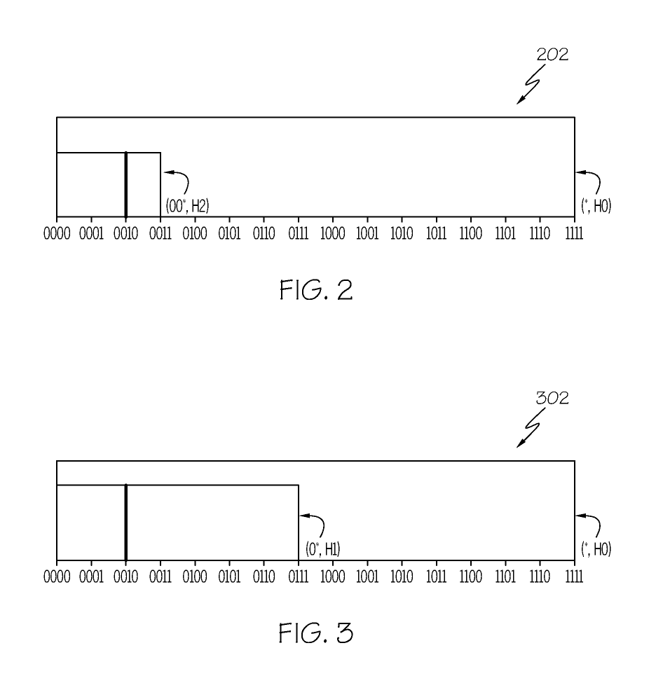

Informally, a rule table is consistent when every lookup returns the action that would be returned if the lookup were done just before a cluster of updates is applied or just after the update cluster is completed. For example, suppose a forwarding table contains rules: (00*, H2), (*, H0). FIG. 2 illustrates these rules on a 4-bit address space initially shown at 202. Now suppose that the following updates are received in a cluster: delete(00*), insert(0*, H1). FIG. 3 gives the prefixes in the forwarding table before the after the updates are applied at 302. The next hop for a data packet with destination address 0010 is shown in FIGS. 2 and 3 with a bold line. If no update has been processed yet, then from FIG. 2 next hop H2 is returned, using shortest range matching (which is equivalent to LMP, as prefix 00* matches). If on the other hand, the cluster of updates is completely processed, then from FIG. 3 the returned next hop is H1.

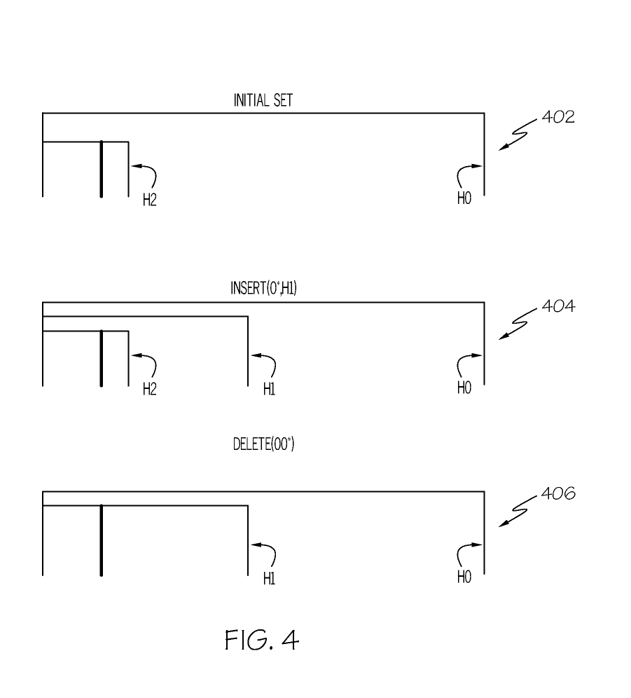

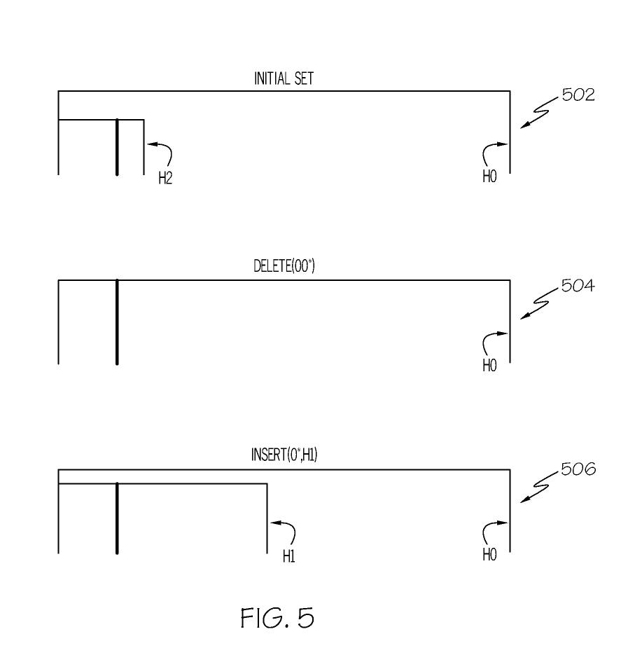

Therefore, as the updates are applied one must ensure that the packets are forwarded to a hop from the set {H1, H2}. For example, if the updates are applied in the following sequence: insert(0*, H1), delete(00*), then consistency is maintained at every step as seen from FIG. 4, which shows an initial set 402, an insert update 404, and a delete update 406, since the hop is picked from set {H1, H2} On the other hand, if the updates are applied as they come, then consistency is not maintained (see FIG. 5 with updates being applied at 502, 504, and 506) because the returned hop is H0∈{H1, H2} following the operation delete(00*). This example deals with batch consistency, which is defined further below.

As updates are received in clusters, redundancies can be found therein. For example, a router may announce and withdraw a route on the same timestamp. Further, it is possible to arrange the updates in a cluster in such a way that the size of the intermediate rule table is the minimum. For example, consider the cluster of updates: insert(rule10), insert(rule11), delete(rule3), delete(rule4), delete(rule5). If the updates are done in this order, then the number of rules in the table first increases by two due to the inserts and finally decreases as the deletes are performed. On the other hand, if the deletes are done first, then there is no temporary increase in the number of entries in the table. If the table size is tightly constrained then picking the deletes first could be helpful in avoiding overflow situations.

Therefore, as will be discussed in greater detail below, various embodiments of the present invention formalize the consistency properties of updated classifiers when updates arrive in clusters. The updates arriving in a cluster are arranged in a consistent sequence that leads to proper packet forwarding and classification, with the same results as if the updates were applied all at a time in a batch. One or more embodiments define and analyze requirements for two types of consistency, namely, batch consistency and incremental consistency. The sequence of updates is represented using precedence graphs to ensure batch consistency, and a heuristic is given to obtain a near optimal batch consistent sequence as a topological ordering of vertices of the precedence graph. Here, optimality is defined with respect to the increase in size of the intermediate rule table, where an optimal sequence guarantees minimum increase in the maximum table size. Various embodiments also provide an algorithm for eliminating redundancies in update operations when a cluster of updates is processed and another algorithm for computing a reduction of a given update sequence based on the “insert”, “delete”, and “change” functions.

Consistent Updates

The following notation used throughout the discussion is given below.
F: a symbol for a filter representing a d-tuple (F[1], F[2], . . . , F[d]), where F[i] is a range specified for an attribute in the packet header such as destination address, source address, source port range, etc. When there are multiple filters, they are represented as F1, F2, . . . .

f: a tuple constructed using destination address, source address, source port range, etc. values from packet header.

A: action corresponding to a filter F. Similarly, A0, A1, A2, . . . .

newA, newA′: new action

(F,A): classifier rule. Similarly, (F1,A1), (F2,A2), . . . .

(P,H): forwarding table rule, where P is a prefix and H is the next hop corresponding to the prefix.

LMP: longest matching prefix

HPM: highest priority matching rule

U: an update sequence

uᵢ: an operation, which could be an insert, delete, or change that is a part of U.

V: a reduced update sequence.

vᵢ: an operation that is part of the reduced sequence V.

S: a reduced and batch consistent update sequence. In another instance it is used to represent an arbitrary sequence. S is also used to represent the overlapping portion of two filters.

sᵢ: an operation that is part of sequence S.

r: number of operations in original update sequence.

m: number of operations in reduced update sequence.

insert (F,A): insert operation that introduces new rule (F,A) to the classifier. Represented also as I, I₁, I₂ etc.

delete(F): delete filter F (and its associated action A). Represented also as D, D₁, D₂ etc.

change(F,newA): change action corresponding to filter F, from A to new A. Represented also as C, C₁, C₂ , etc.

T₀: packet classification device

Tᵢ(U): packet classification device obtained after applying i operations from update sequence U, starting from the first operation.

R: packet classification device

action(f,R): action corresponding to the highest priority matching rule for filter f is classifier R.

priority (F,A): priority of rule (F,A) in the packet classification device.

|T₀|: number of rules in a classifier table initially.

|Tᵢ(S)|: number of rules in classifier table after i updates from sequence S has been applied.

max_{0≦i≦m}|Tᵢ(S)|: maximum increase in rule table size as each update numbered 0 through m in the batch update sequence S is applied on the classifier table.

optB(T₀,U): maximum increase in rule table size as all the updates numbered 0 through m in an optimal batch consistent update sequence S (corresponding to original update sequence U) are applied sequentially to the classifier table.

optI(T₀,U): maximum increase in rule table size as all the updates numbered 0 through m in an optimal incremental consistent update sequence corresponding to U are applied sequentially to the classifier table.

#inserts(U),#deletes(U): Number of inserts and deletes, respectively, in the update sequence U.

G: precedence graph for the update sequence V.

E(G): set of directed edges of G.

Q: set of pairs of (a,b) values corresponding to different update sequences.

σ(Q): permutation of (a,b) pairs.

B(i): Sum of b values in a permutation σ(Q) of (a,b) pairs.

A(i): Sum of b values till the (i−1) pair and the a value for the ith pair.

Δ: Increase in table size as two sequences are merged.

The following terms are now defined: reduction of an update sequence, a batch consistent sequence, and an incremental consistent sequence.

Definition 1: Let U=u₁, . . . , uᵣ be an update sequence; each is an insert, delete, or change operation. The update sequence V(U) (or simply V) derived from the update sequence U in the following manner is called the reduction of U.

Examine the update operations in the order u₁, u₅, . . . . Let F be the field tuple associated with the operation uᵢ being examined. If F occurs next in uⱼ, j>i, do the following:
1. If uᵢ=change(F,newA) and uⱼ=change(F,newA′), remove uᵢ from U. If newA′ is the same as the existing action for F in the rule table, then remove uⱼ from U as well.
2. If uᵢ=change(F,newA) and uⱼ=delete(F), remove uᵢ from U
3. If uᵢ=delete(F) and uⱼ=insert(F,A), remove uᵢ from U and replace uⱼ by change(F,A). (uⱼ may also be removed from U when action A equals the current action associated with F in the classifier.)
4. If uᵢ=insert(F,A) and uⱼ=change(F,newA), remove uᵢ from U and replace uⱼ by insert(F,newA).
5. If uᵢ=insert(F,A) and uⱼ=delete(F), remove uᵢ and uⱼ from U.

Note that the remaining four possibilities for uᵢ and uⱼ ((change, insert), (delete, change), (delete, delete), and (insert, insert)) are invalid. For example, the reduction of U=insert(F1,A1), insert(F2,A2), delete(F1,A1) is V=insert(F2,A2). It is easy to see that a field tuple F may be associated with at most one operation in the reduction of U.

Definition 2: Let U=uᵢ, . . . , uᵣ be an update sequence; each is an insert, delete, or change operation. Let T₀ be a packet classification device and let Tᵢ(U) be the state of this classifier after the operations u₁, . . . , uᵢ have been performed, in this order, on T₀. Let T₀(U)=T₀ and let action(f,R) be the action associated with the highest priority matching rule for field tuple f in packet classification device R. Let S=s₁, . . . , sₘ be another update sequence. S is batch consistent with respect to T₀ and U if and only if (iff)T_{T}(U)=Tₘ(S)̂∀i∀f[action(f,Tᵢ(S)]∈{action(f,T₀),action(f,Tᵣ(U))}. S is incremental consistent with respect to T₀ and U iff:

Tᵣ(U)=Tₘ(S)̂∀i∀f[action(f,Tᵢ(S)]∈{action(f,T₀), . . . , action(f,Tᵣ(U))}.

Note that two tables are equal iff they comprise the same rules. Further, although U is always incremental consistent with respect to itself, it is generally not batch consistent with respect to itself (i.e., S=U) and a table T₀. For example, suppose U=insert(F1,A1), delete(F1,A1) and T₀={(*,A0)}, where “*” stands for the default rule containing * for all fields and which therefore any field tuple would match. Further, let A0≠A1 and priority (F1,A1)>priority(*,A0). Then, T₂(U)=T₀ and action(f,T₀)=action(f,T₂)=A0 for all f. However, even though Tᵣ(U)=Tₘ(S), action(f,T₁,(S))=A1≠A0 for every f that matches classifier rule (F1,A1).

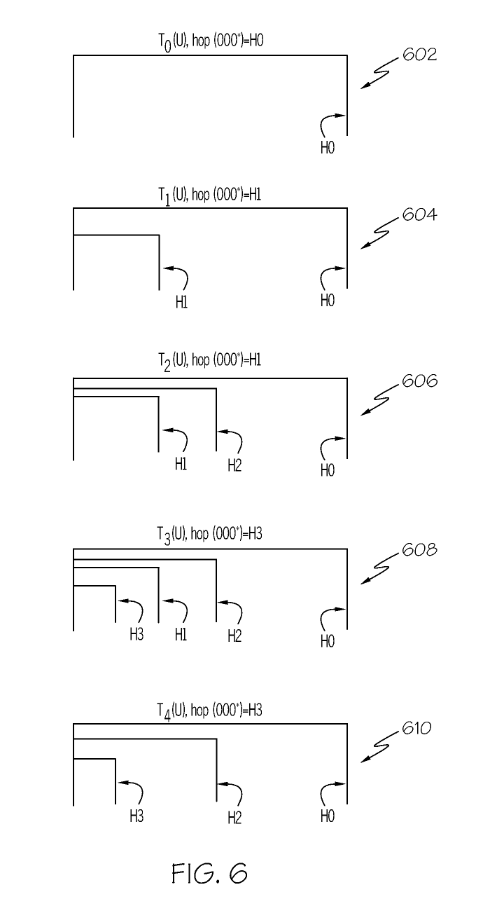

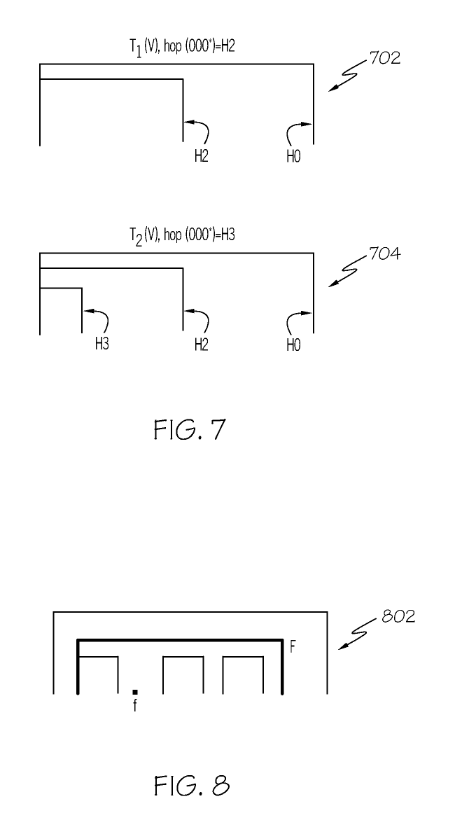

Note that the reduced update sequence V(U) may be neither batch nor incremental consistent with respect to U and T₀. For example, suppose that T₀={*,H0} and U=insert(00*,H1), insert(0*,H2), insert(000*, H3), delete(00*). FIG. 6 shows T₀, T₁(U), . . . , T₄(U) at 602 to 610. Batch consistency requires the next hops for destination addresses matched by 000* to be in set Hb={H0,H3} while incremental consistency requires these next hops to be in set Hi={H0,H1,H3} as illustrated in FIG. 6. FIG. 7 shows T₁(V) 702 and T₂(V) 704 for the reduced sequence V(U)=insert(0*,H2), insert(000*,H3). As can be seen, nextHop(d,T₁(V))=H2 and H2∉Hb, H2∉Hi for addresses d matched by 000*. So, V(U) is neither batch nor incremental consistent with respect to U and T₀.

Theorem 1 establishes the existence of a batch consistent update sequence for every classifier T₀ and every update sequence U. Note that the existence of an incremental consistent update sequence follows from the earlier observation that U is incremental consistent with respect to itself and every T₀. This follows also from Theorem 1 as every batch consistent update sequence is incremental consistent as well. An incremental consistent sequence may not, however, be batch consistent.

Theorem 1: For every classifier T₀and update sequence U, there exists a batch consistent update sequence S. Proof: Let S=s₁, . . . , sₘ be derived from U=u₁, . . . , uᵣ as below. Step 1 Let V=v₁, . . . , vₘ be the reduction of U. Step 2 Reorder the operations of V so that the inserts are at the front and in decreasing order of priority; followed by the change operations in any order; followed by the deletes in increasing order of priority. Call the resulting sequence S.

S is batch consistent with respect to U and every T₀, as shown below. First, can be seen that Tᵣ(U)=Tₘ(V)=Tₘ(S). Therefore, only the following needs to be shown: ∀i∀f[action(f,Tᵢ(S))]∈{action(f,T₀),action(f,Tₘ(S))}. The proof is by induction on i. For the induction base, i=0, T₀(S)=T₀, and so ∀f[action(f,T₀(S))=action(f,T₀)]. For the induction hypothesis, assume that ∀f[action(f,Tⱼ(S))∈{action(f,T₀),action(f,Tₘ(S))}] for some j, 0≦j<m. In the induction step, it is shown:

∀f[action(f,Tⱼ₊₁(S))∈{action(f,T₀),action(f,Tₘ(S))}] (EQ. 1).

If ∀f┌action(f,Tⱼ₊₁(S)=action(f,Tⱼ(S))], then Equation 1 follows from the induction hypothesis. So, suppose there is an f such that action(f,Tⱼ₊₁,(S))≠action(f,Tⱼ(S)). There are three cases to consider for sⱼ₊₁—insert(F,A), change(F,newA), and delete(F). When sⱼ₊₁=insert(F,A) or sⱼ₊₁=change(F,newA), it must be that HPM (f,Tⱼ₊₁(S))=F (assuming overlapping rules have different priority). Because of the ordering of operations in S, the remaining operations sⱼ₊₂, . . . do not change either the highest priority matching rule for f or the action associated with this matching rule. So, HPM(f,Tₘ(S))=F and action(f,Tⱼ₊₁(S))=action(f,Tₘ(S)) (see FIG. 8 showing Tⱼ₊₁ 802 for a forwarding table. F is newly inserted/changed prefix, f is the destination address on a packet). When sⱼ₊₁=delete(F), it must be that HPM(f,Tⱼ₊₁(S))=F′, where F′ is the highest priority tuple in Tⱼ₊₁(S) that matches f. Note that priority(F′)<priority(F). Because of the ordering of operations in S, the remaining operations sⱼ₊₂, . . . do not change either the highest priority matching rule for f or the action associated with this matching rule. So, HPM (f,Tₘ(S))=HPM(f,Tⱼ₊₁(S))=F′ and action(f,Tⱼ₊₁(S))=action(f,Tₘ(S)).

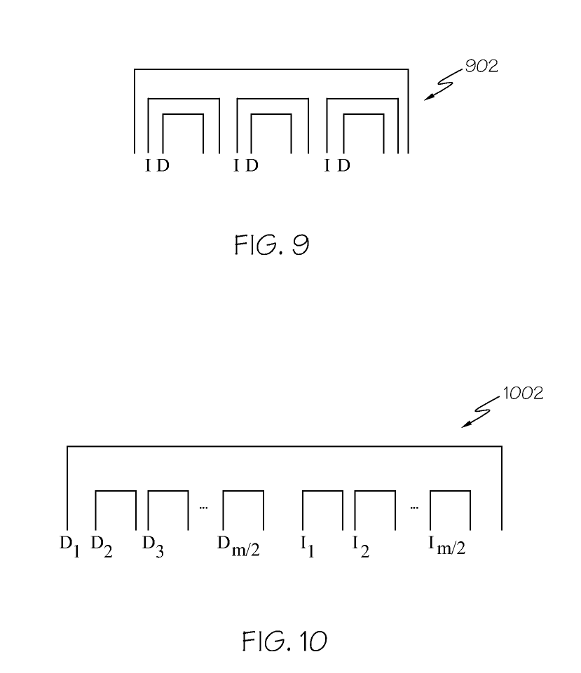

From the proof of Theorem 1, one can see that for an update sequence to be batch consistent, it is necessary only that whenever an operation changes the action for a tuple f , that change be reflected to the action in the final table Tᵣ(U). Using this observation, it is possible to construct additional batch consistent update sequences. For example, one embodiment can partition the operations in the reduction of U so that the field tuples in one partition are disjoint from those covered by other partitions. Then, for each partition, this embodiment can order the operations as in the construction of Theorem 1 and concatenate these orderings to obtain a batch consistent update sequence. Different batch consistent update sequences may result in intermediate router tables of different size. As an example, consider the reduced update sequence 902 of FIG. 9 for a forwarding table. The outermost prefix and all prefixes marked D are in T₀. Those marked I are prefixes that are to be inserted and those marked D are to be deleted. The batch consistent sequence constructed in the proof of Theorem 1 performs all of the inserts first and then the deletes. If there are a inserts, the table size increases by a following the last insert and then decreases back to the size of T₀ as the deletes complete. For the update sequence to succeed (when inserts/deletes are done incrementally, i.e., one at a time), there must be a units of additional table capacity. An alternative batch consistent update sequence follows each insert with the deletion of its enclosed prefix that is labeled D in the FIG. 9. Using this sequence, only one additional unit of table capacity is required and this is optimal for the given example as it is not possible to do a delete before its enclosing insert and maintain batch consistency (unless, of course, the table is locked for lookup from the start of a delete to the completion of its enclosing insert).

Now it will be proved that a reduced sequence obtained using the Definition 1 has the smallest number of operations and it is not possible to reduce it further.

Theorem 2: For every classifier T₀ and update sequence U=u₁, . . . , uᵣ, the reduced sequence V(U) has the smallest number of operations needed to transform T₀ to Tᵣ(U).

Proof: Consider any sequence S that transforms T₀ to Tᵣ(U). Let V(S) be the reduction of S. Clearly, |V(S)|≦|S| and V(S) also transforms T₀ to Tᵣ. It will be shown that |V(U)|≦|V(S)|, thereby proving the theorem.

Consider any vᵢ∈V(U). If v₁=insert(F,A), then F∈T₀ (follows from the correctness of U with respect to T₀ and the definition of V(U)) and F∈Tᵣ(U). Consequently, insert (F,A′)∈V(S). Since F appears only once in V(S),A′=A. So, vᵢ∈V(S). If vᵢ=delete(F), then F∈T₀ and F∈Tᵣ(U). So, delete(F)∈V(S). Similarly, when vᵢ=change(F,newA),vᵢ∈V(S). So, V(U)⊂V(S) and |V(U)|≦|V(S)|.

Definition 3: A batch (incremental) consistent sequence S=s₁, . . . , sₘ for U and T₀ is optimal iff it minimizes max_{0≦i≦m}{|Tᵢ(S)|} relative to all batch (incremental) consistent sequences.

Theorem 3 below establishes a relationship on the maximum growth of table size as a batch consistent update sequence is applied and as an incrementally consistent update sequence is applied on rule table T₀.

Theorem 3: Let S be an optimal batch consistent sequence for U and T₀. Let optB(T₀,U)=max_{0≦i≦m}{|Tᵢ(S)|}. Let optI(T₀,U) be the corresponding quantity for an optimal incremental consistent sequence. optB(T₀,U)−m/2≦optI(T₀,U)≦optB(T₀,U) and both upper and lower bounds on optI(T₀,U) are tight.

Proof: optI(T₀,U)≦optB(T₀,U) follows from the observation that every batch consistent sequence also is incremental consistent. To see that this is a tight upper bound, consider the case when U is comprised only of change (or only of insert or only delete) operations. Now, optI(T₀,U)=optB(T₀,U).

To establish optB(T₀,U)−m/2≦optI(T₀,U), it is noted that optI(T₀,U)≧|T₀|+max{0,#inserts(U)−#deletes(U)} and optB(T₀,U)≦|T₀|+#inserts(U). So, optB(T₀,U) −optI(T₀,U) is maximum when #inserts(U)=#deletes(U). Since, #inserts(U)+#deletes(U)≦m, optB(T₀,U)−optI(T₀,U) is maximum when #inserts(U)=#deletes(U)=m/2. At this time, optB(T₀,U)−optI(T₀,U)=m/2. Hence, optB(T₀,U)−m/2≦optI(T₀,U). For the tightness of this bound, consider a sequence U 1002 of m/2 deletes followed by m/2 inserts as in FIG. 10 (one delete that encloses m/2 inserts and m/2−1 deletes all of which are independent). Since U is incremental consistent with itself, optI(T₀,U)=|T₀|. Batch consistency limits us to permutations of U in which the inserts precede all the deletes. So, optB(T₀,U)=|T₀|+m/2. Hence, optB(T₀,U)−m/2=optI(T₀,U).

Batch Consistent Sequences

When performing the updates U=u₁, . . . , uᵣ in a batch consistent manner, one primary objective is to perform the fewest possible inserts/deletes/changes to transform T₀ to Tᵣ and one-secondary objective is to perform these fewest updates in a batch consistent order that minimizes the maximum size of an intermediate table. The primary objective is met by using the reduction V(U) of U (Theorem 2). For the secondary objective, one embodiment constructs a precedence graph. The following discusses this precedence graph. The following also discusses how a batch consistent update sequence can be obtained from a precedence graph, and a heuristic for producing a batch consistent update sequence that results in near-optimal growth in the size of the intermediate rule table.

One embodiment constructs an m vertex digraph G(V) from V=v₁, . . . , vₘ. Vertex i of G represents the update operation vᵢ. Let (Fᵢ,Aᵢ) be the rule associated with update vᵢ, 1≦i≦m. There is a directed edge between vertices i and j iff (a) all fields in tuples Fᵢ and Fⱼ overlap, that is Fᵢ∩Fⱼ=S, S≠Ø, where S is a tuple built from fields representing overlapping regions of Fᵢ and Fⱼ, (b) there is no rule (Fₖ,Aₖ) such that Fₖ∩S≠Ø and priority of (Fₖ,Aₖ) lies between those of rules (Fᵢ,Aᵢ) and (Fⱼ,Aⱼ), and (c) one of the following relationships between vᵢ and vⱼ hold good, assuming without loss of generality that priority(Fᵢ,Aᵢ)>priority(Fⱼ,Aⱼ):
1. vᵢ and vⱼ are inserts [symbol] (i,j)∈E(G) , where E(G) is the set of directed edges of G.
2. vᵢ is an insert and vⱼ is a delete [symbol] (i,j)∈E(G).
3. vᵢ and vⱼ are deletes [symbol] (j,i)∈E(G).
4. vᵢ is a delete and vⱼ is an insert [symbol] (j,i)∈E(G).
5. vᵢ is an insert and vⱼ is a change [symbol] (i,j)∈E(G).
6. vᵢ is a delete and vⱼ is a change [symbol] (j,i)∈E(G).

Definition 4: i is an immediate predecessor of j in G iff(i,j)∈E(G). i is a predecessor of j iff there is a directed path from i to j in G.

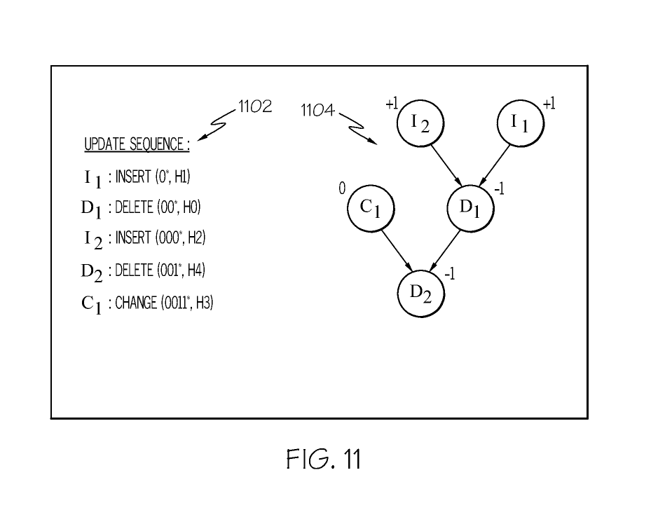

A weight of 1, 0, or −1 is assigned to vertex i of precedence graph G depending on whether vᵢ is an insert, change, or delete. FIG. 11 gives an example of a reduced update set V 1102 and its corresponding digraph G 1104. One can verify that a permutation of a reduced update set V is batch consistent iff it corresponds to a topological ordering of the vertices of G. Further, for every topological ordering, |Tᵢ|−|T₀| equals the sum of the weights of the first i vertices in the ordering.

Definition 5: For a given topological order, wᵢ is defined to be the sum of the weights of the first i vertices. The max weight of a topological order is max{wᵢ}. An optimal topological ordering is a topological ordering that has minimum max weight.

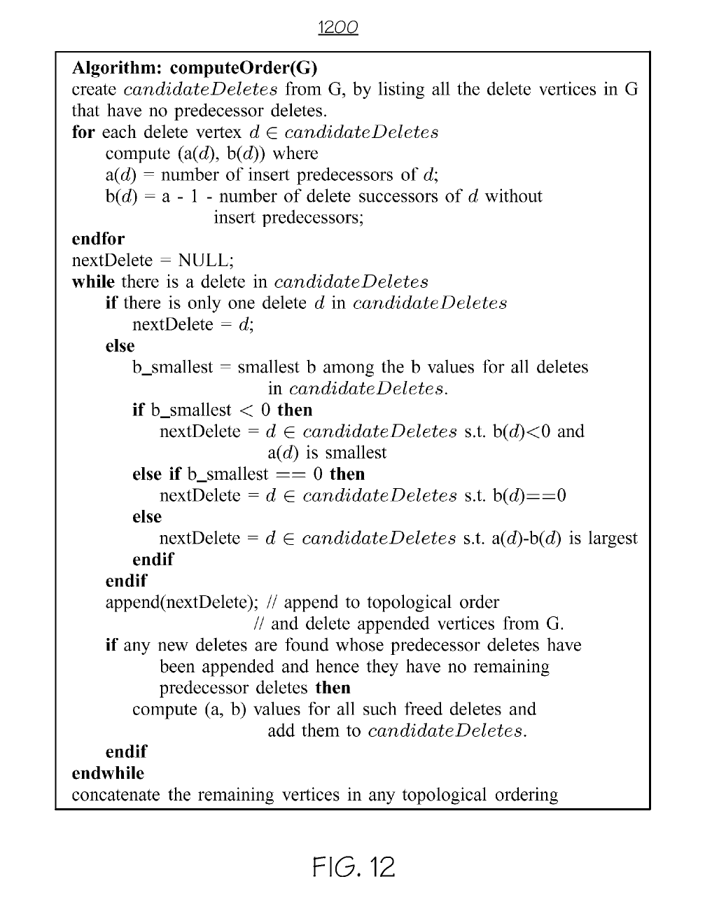

Notice that the secondary objective is met by an optimal topological ordering. As discussed above, one or more embodiments provide an efficient heuristic/algorithm 1200 (shown in FIG. 12) in which a topological order is constructed in several rounds. In each round, one of the remaining deletes is selected to be the next delete in the topological order being constructed. In case no delete remains in G, any topological ordering of the remaining vertices may be concatenated to the ordering so far constructed to complete the overall topological order. Assume at least one delete remains in G. Only deletes that remain in G and that have no delete predecessors are candidates for the next delete. Each candidate delete d is assigned an (a,b) value where a is the number of insert predecessors of d and b=a−the number of delete successors of d (including d) that have no insert predecessors that are not also predecessors of d.

From the candidate deletes, one is selected using the following rule.
1. If the least b is less than 0, from among the candidate deletes that have negative b, select one with least a.
2. If the least b equals 0, select any one of the candidate deletes that have b=0.
3. If the least b is more than 0, from among the candidate deletes, select one with largest a−b.

Once the next delete for the topological ordering is selected, one embodiment concatenates its remaining predecessor inserts and changes (these inserts and changes are first put into topological order) to the topological ordering being constructed followed by the selected delete d followed (in topological order) by the delete successors (and the remaining change predecessors of these delete successors) of d that have no remaining insert predecessors. All newly added vertices to the topological ordering being constructed (together with incident edges) are deleted from G before commencing the next round selection. The heuristic 1200 of FIG. 12 is motivated by the following two theorems.

Theorem 4: For every G, there exists an optimal topological ordering in which between any two successive deletes dᵢ and dᵢ₊₁ there are only the predecessor inserts and changes of dᵢ₊₁ that are not predecessor inserts and changes of any of the deletes d₁, . . . , dᵢ. Here d₁, . . . are the deletes of V indexed in the order they appear in the topological ordering.

Proof: Consider an optimal topological ordering of G. Examine the deletes left to right. Let dᵢ₊₁ be the first delete such that there is an insert or change between dᵢ and dᵢ₊₁ that is not a predecessor of dᵢ₊₁. All inserts and changes between dᵢ and dᵢ₊₁ that are not predecessors of dᵢ₊₁ can be moved from their present location in the topological ordering (without changing their relative ordering) to just after dᵢ₊₁. This relocation of the inserts and changes yields a new topological ordering that also is optimal. Repeating this transformation a finite number of times results in an optimal topological ordering that satisfies the theorem.

For the second theorem that motivates the heuristic 1200 of FIG. 12, let S be a sequence of inserts and deletes to be performed (in the given order) on a forwarding table. The a value of the sequence S is the maximum increase in table size when the sequence of inserts and deletes is done in the given order and b is the increase in table size following the last insert/delete in S. For example, when S=I₁I₂D₁I₃D₂D₃, a=2 and b=0. Suppose there are given n sequences S₁, S₂, . . . , Sₙ of inserts and deletes that are to be concatenated these into a single sequence. Every permutation of S₁, S₂, . . . , Sₙ defines a legal concatenation. However, different permutations have different (a,b) values. For example, when n=2, S₁=/I₁I₂I₃I₄D₁D₂D₃D₄ and S₂=I₅I₆D₅D₆D₇D₈, the permissible concatenations/permutations are S₁S₂ and S₂S₁. The (a,b) values for S₁, S₂, S₁S₂ and S₂S₁ are, respectively, (4,0), (2,−2), (4,−2) and (2,−2). The permutation S₂S₁ results in the smallest increase in table size and is therefore the optimal permutation.

The following notation is now introduced:
1. Q={(a₁,b₁),(a₂,b₂), . . . , (aₙ,bₙ)} is a set of (a,b) values corresponding to n update sequences S₁, S₂, . . . , Sₙ.
2. σ(Q) is a permutation of the pairs of Q and σ(Q,i) is the i th pair in this permutation. For simplicity, σ(Q) and σ(Q,i) will be abbreviated to σ and σ(i).
3. B(σ(Q),i)=Σⱼ₌₁^{i-k b}_{σ(j)}.
B(σ(Q),i) will be abbreviated to B(i). Note that B(i) is the sum of the second coordinates (or b values) of the first i pairs of σ.
4. A(σ(Q),i)=maxi_{1≦j≦i}{B(j−1)+a_{σ(j)}} and is abbreviated A(i).
σ(Q) is an optimal permutation iff it minimizes A(n).

Next, a theorem is given and proved to construct an optimal permutation of a collection of update sequences.

Theorem 5: Let σ(Q) be such that:
1. The pairs with negative b s come first followed by those with zero b s followed by those with positive b s.
2. The pairs with negative b s are in increasing (non-decreasing) order of a s.
3. The pairs with zero b s are in any order.
4. The pairs with positive b s are in decreasing (non-increasing) order of a−b.
σ(Q) is an optimal sequence.

Proof: First, it is shown that permutations that violate one of the listed conditions cannot have a smaller A(n) than those that satisfy all conditions. Consider a permutation that does not satisfy the conditions of the theorem. Suppose that the first violation of these conditions is at position i of the permutation (i.e., pairs i and i+1 of the permutation violate one of the conditions). Let (aᵢ,bᵢ) be the ith pair and (aᵢ₊₁,bᵢ₊₁) be the i+1st pair. Let Δ=max{aᵢ,bᵢ+aᵢ₊₁} and Δ′=max{aᵢ₊₁,bᵢ₊₁+aᵢ}. It will be shown that that Δ′≦Δ. This together with the observation that A(i +1)=max{A(i−1), B(i−1)+aᵢ, B(i−1)+bᵢ+aᵢ₊₁} implies that swapping the pairs i and i+1 does not increase A(i+1). By repeatedly performing these violation swaps a finite number of times, a permutation is obtained that satisfies the conditions of the theorem and that has an A(n) value no larger than that of the original permutation. Hence, a permutation that violates a listed condition cannot have a smaller A(n) than one that satisfies all conditions.

To show Δ′≦Δ, the four possible cases for a violation of the conditions of the theorem are considered: (1) bᵢ≦0 and bᵢ₊₁<0 (violation of condition 1), (2) bᵢ>0 and bᵢ₊₁=0 (violation of condition 1), (3) aᵢ>aᵢ₊₁, bᵢ<0, and bᵢ₊₁<0 (violation of condition 2), and (4) aᵢ−bᵢ<aᵢ₊₁−bᵢ₊₁, bᵢ>0, and bᵢ₊₁>0 (violation of condition 4). Note that condition 3 cannot be violated as this condition permits arbitrary ordering of pairs with zero b. In fact, it can be seen that when bᵢ=bᵢ₊₁=0, Δ=Δ′=max{aᵢ, aᵢ₊₁} and swapping the pairs i and i+1 does not affect A(i+1).

bᵢ+aᵢ₊₁≧aᵢ₊₁ and bᵢ₊₁+aᵢ<aᵢ. So, Δ′≦Δ. Case (1)

Now, Δ′=max{aᵢ₊₁,bᵢ₊₁+aᵢ}≦max{aᵢ₊₁, aᵢ}=Δ. Case (2)

Now, Δ′<aᵢ=Δ. Case (3)

From aᵢ−bᵢ<aᵢ₊₁−bᵢ₊₁, it follows that aᵢ+bᵢ₊₁<bᵢ+aᵢ₊₁. Case (4)

From this and bᵢ₊₁>0, aᵢ<bᵢ+aᵢ₊₁ is obtained. Hence, Δ=bᵢ+aᵢ₊₁. If aᵢ₊₁≧bᵢ₊₁+aᵢ, Δ′=aᵢ₊₁<Δ. If aᵢ₊₁<bᵢ₊₁+aᵢ, Δ′=bᵢ₊₁+aᵢ<bᵢ+aᵢ₊₁=Δ.

To complete the proof, the following needs to be shown: σ's that satisfy the conditions of the theorem have the same value of A(n). Specifically, that Δ=Δ′ whenever (c′)aᵢ=aᵢ₊₁,bᵢ<0, and bᵢ₊₁<0 (tie in condition 2), and (d′)aᵢ−bᵢ=aᵢ₊₁−bᵢ₊₁,bᵢ>0, and bᵢ₊₁>0 (tie in condition 4).

Since the vertex weights in G are 1, 0, and −1, the max weight of a topological ordering cannot exceed m, the number of vertices in G and cannot be less than −1. The maximum number of table entries occurs, for example, when all vᵢ are inserts and the minimum happens, for example, when all vᵢ are deletes. So, a topological ordering may have a max weight that exceeds the minimum max weight by O(m). The heuristic 1200 of FIG. 12 can produce topological orderings whose max weight is Ω(m) more than that of the optimal ordering.

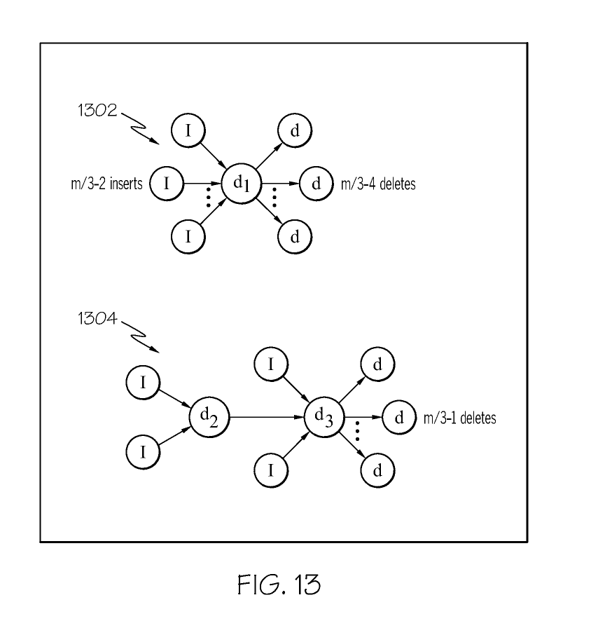

For example, consider the digraph of FIG. 13 that has two components. The first component 1302 is comprised of a delete d₁ that has m/3−2 inserts that are immediate predecessors and m/3−4 immediate successor deletes. The second component 1304 has a delete d₂ that has 2 immediate predecessor inserts and a successor delete d₃ that also has 2 immediate predecessor inserts and m /3−1 immediate successor deletes. Deletes d₁ and d₂ are the candidate deletes during the first round of the heuristic 1200 of FIG. 12. Their (a,b) values are (m/3−2,−1) and (2, 1), respectively. Delete d₁ is selected by the heuristic 1200 of FIG. 12 and the partial topological ordering constructed has m/3−2 inserts followed by m/3−3 deletes. In the next round d₂ preceded by its 2 predecessor inserts is added to the ordering. Finally, in the third round, d₃ preceded by its 2 predecessor inserts and followed by its m/3−1 successor deletes is added. The max weight of the constructed topological ordering is m/3−2 (assume m/3≧4). In an optimal ordering, the first component appears after the second and the max weight is 3. So, the heuristic ordering has a max weight that is m/3−5=O(m) more than optimal.

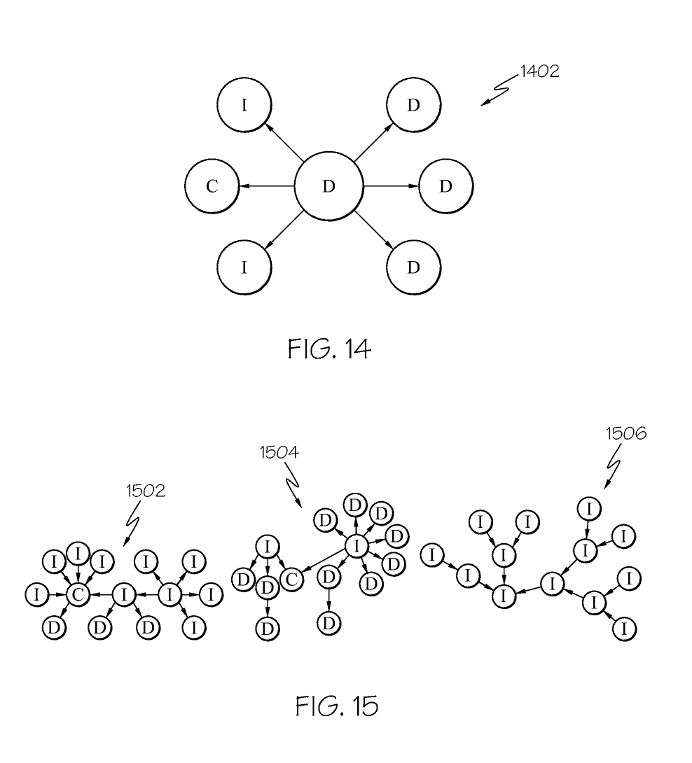

Whenever each component of G is a delete star 1402 as shown in FIG. 14, the heuristic 1200 of FIG. 12 finds an optimal ordering. Note that in a delete star, there is a delete vertex all of whose predecessors are inserts and/or changes and all of whose successors are deletes that have no additional predecessor inserts. This follows from Theorem 5 and the observation that each component has only one delete that ever becomes a candidate for selection by the heuristic 1200 of FIG. 12. In general, whenever no component of G has two deletes that become candidates for selection, the heuristic 1200 of FIG. 12 obtains an optimal topological ordering. It should be noted that the G s that arise in practice have a sufficiently simple structure for which the heuristic 1200 of FIG. 12 obtains optimal topological orderings. FIG. 15 shows a few examples 1502, 1504, 1506 of the more complex components in the G s of trace update data for forwarding tables.

Incremental Consistent Sequences

When performing the updates U=u₁, . . . , uᵣ in an incremental consistent manner, the primary and secondary objectives are the same as those for batch consistency. The primary objective is to perform the fewest possible inserts/deletes/changes to transform T₀ to Tᵣ. The secondary objective is to perform these fewest updates in an incremental consistent order that minimizes the maximum size of an intermediate table. The primary objective is met by using the reduction V(U) of U (Theorem 2). Note that since V(U) has a batch consistent ordering, it has also an incremental consistent ordering. For the secondary objective, however, there is no digraph H(V) whose topological orderings correspond to the permissible incremental consistent orderings of V(U). To see this, consider a forwarding table T₀={(*,H0),(00*, H1)} and U=u₁, u₂, u₃=delete(00*), insert(000*,H2), insert(0*,H3). For this example, V(U)=U and the incremental consistent orderings are u₁u₂u₃, u₂u₁u₃,u₂u₃u₁, and u₃u₂u₁. The remaining two orderings u₁u₃u₂ and u₃u₁u₂ are not incremental consistent. To see that u₁u₃u₂, for example, is not incremental consistent, note that following u₃, the next hop for destination addresses that are of the form 000* is H3 whereas in the original ordering u₁u₂u₃ these destination addresses have next hop H1 initially, H0 following u₁, and H2 following both u₂ and u₃.

Any H(V) that disallows the topological ordering u₁u₃u₂ must have at least one of the directed edges (u₃,u₁), (u₂,u₁), and (u₂,u₃). However, the presence of any one of these edges in H(V) also invalidates one of the four permissible orderings. So, no H(V), whose topological orderings coincide exactly with the set of permissible orderings, exists. It should be noted that one or more embodiments can also formulate meta-heuristic (e.g., simulated annealing, genetic, etc.) based algorithms to determine near optimal incremental consistent orderings of V(U).

Experiments

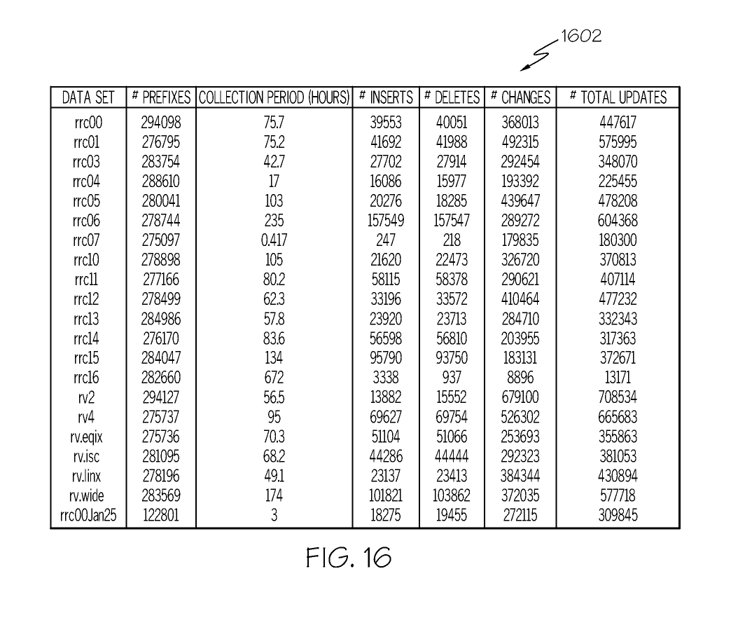

The inventors have applied the heuristic 1200 of FIG. 12 discussed above to obtain near optimal batch consistent sequences on two sets of benchmarks. The first set of benchmarks 1602 consist of 21 datasets derived from BGP update sequences of various routers, shown in FIG. 16 where the first and second columns showing the name and the total number of prefixes in the initial forwarding table for each dataset. The third column gives the period for which the data has been extracted.

Columns four to seven, respectively, give the number of “insert”, “delete” and “change” operations, and the total number of operations for each dataset. All the datasets except rrc00Jan25 were collected starting from the zero hour on Feb. 1, 2009. The last one, rrc00Jan25, is for the three hour period from 5:30am to 8:30am on Jan. 25, 2003, which corresponds to the SQLSlammer worm attack (See, [25], which is hereby incorporated by reference in its entirety).

The “insert”, “delete”, and “change” operations in FIG. 16 are derived from BGP update messages received by the router. BGP is essentially an incremental protocol in which a router generates update messages only when there is a change in its routing state. Such a change can be in the network topology (for example, when a router fails or comes up after failure or is added to the network) or in the routing policy. The BGP update messages consisting of route announcements and withdrawals are sent over semi-permanent TCP connections to the neighboring routers.

A route announcement advertises a new route to a prefix. Upon receiving an announcement, a router compares the newly advertised route with the existing ones for the same prefix in the routing information base (RIB or routing table). If there are no existing routes then a new prefix is inserted to the forwarding table along with the next hop as IP address of the BGP peer from which the announcement was received. If, on the other hand, there are existing routes, then the new route is compared with the existing ones by applying the BGP selection rules. If the new route is superior to the best among the existing routes, then the rule corresponding to the route is changed in the forwarding table by changing the next hop to point to the BGP peer that sent the new route announcement. If the new route is inferior to the best existing route, then the announcement has no effect on the forwarding table and hence the routing policy. The new route is stored in the RIB in any case. The inventors generated the “insert” and “change” next hop operations corresponding to route announcements in the experiments in keeping with the forwarding table update strategy of BGP.

A route withdrawal message, similarly, triggers a number of actions at a router. The router removes the route from the RIB, and then checks if there are existing routes from different peers to the same prefix. If there are no such routes, then the forwarding rule for the route is deleted from the forwarding table. On the other hand, if there are more routes and the withdrawn route was the best among them, then the next best route is picked from the remaining routes by applying the BGP selection rules and the forwarding table is updated by changing appropriately the next hop of the rule corresponding to the route. Otherwise, if the withdrawn route is not the best among the existing routes, then the forwarding table is left unchanged. Just as for route announcements, the inventors generated the “delete” and “change” next hop operations corresponding to the route withdrawals in line with the BGP update strategy for forwarding tables. Therefore, some of the withdrawals may not lead to any operations, just as some of the announcements.

Note that the heuristic 1200 of FIG. 12 changes the order in which updates (received in a batch) are applied to the forwarding table. Thus, the forwarding table is the only entity that is affected, which in turn, affects packet forwarding. The heuristic 1200 of FIG. 12 does not affect the routing table (RIB) or any BGP message being sent out from the router. Thus, the heuristic 1200 of FIG. 12 does not affect the various nuances of BGP including the BGP convergence time.

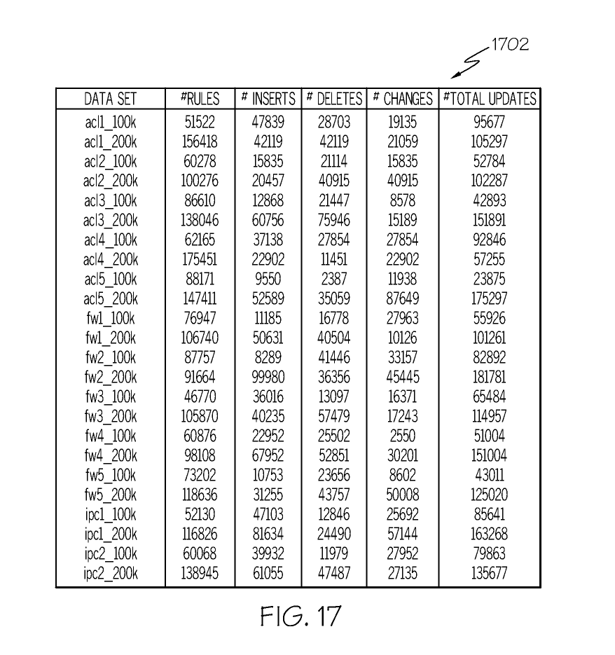

The second set of benchmarks 1702 consist of 24 synthetic classifiers generated using ClassBench [16] as shown in FIG. 17. The first column in FIG. 17 presents the names of the classifiers, the second column shows the number of rules in each of the classifiers, and columns three to six give the number of inserts, deletes, and change operations in the update traces as well as the total number of update operations for each dataset. The inventors used 12 seed files based on access control lists (acl), firewalls (fw) and IP chains (ipc) to generate 24 classifiers. Each rule consists of the fields: source address, destination address, source port range, destination port range, protocol. The inventors created an update trace from the classifiers by marking rules for insertion/deletion/change randomly, and later removing the rules marked for insertion. The corresponding insert, delete and change operations are shuffled and then written to the update file.

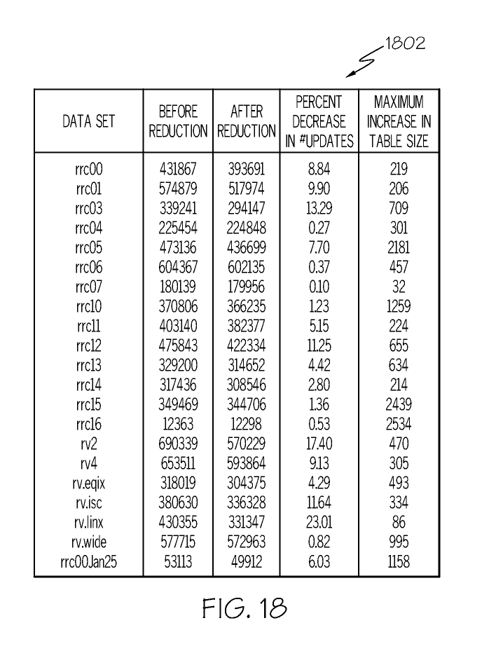

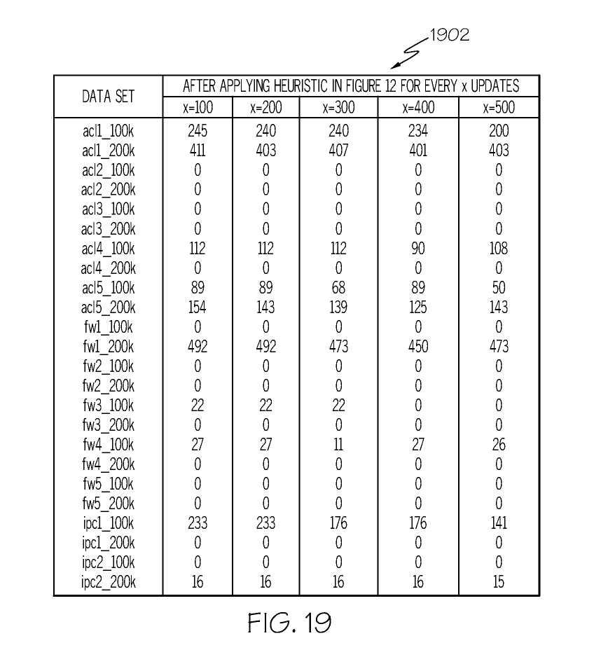

FIG. 18 shows a table 1802 of the total number of update operations that remain after applying the reduction technique discussed above to each update batch of FIG. 16. All updates with the same timestamp define a batch. It should be noted that the Internet Engineering Task Force (IETF) recommends that minRouteAdver timer be used and the suggested value is 30 seconds between consecutive announcements to the same destination. If this timer is set on a router then it is expected that there would be fewer redundancies in update operations.

When reduction is applied to batches of updates with the same timestamp, the reduction of the number of updates varied between 0.1% (rrc07) and 23% (route-views.linx) with an average of 6.64%. After applying reduction to remove the redundant operations, the remaining operations are arranged in a consistent sequence using the near optimal heuristic of FIG. 12. The fifth column in FIG. 18 gives the maximum growth in the forwarding table.

The update traces for the classifier benchmarks (FIG. 17) were synthetically generated to be free from redundancies. FIG. 19 shows a table 1902 of the growth in the packet classification devices compared to the initial table size. The first column presents the names of each dataset, whereas the other columns indicate the maximum increase in size of the classifier as the updates are clustered as indicated, and are subjected to consistent sequencing using the heuristic of FIG. 12. The components of the precedence graph are simplistic and the heuristic of FIG. 12 produce optimal update sequences for all the classifier benchmarks used in the experiments. When the heuristic 1200 of FIG. 12 is applied to the entire set of updates, then a remarkable drop is seen in the maximum growth to zero for most datasets in FIG. 19. This can be explained by the large number of deletes in the update sequences and the availability of more deletes that require no prior inserts, as all the updates are considered. These deletes are put first in the new sequence freeing up enough space in the rule table to hold the newly inserted rules without any increase in the size compared to the initial table.

Operational Flow Diagrams

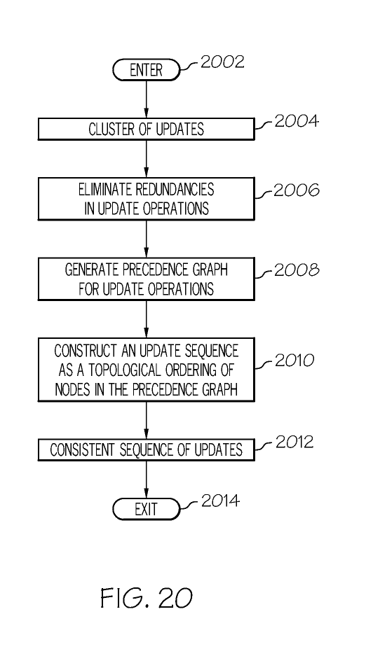

FIG. 20 is an operational flow diagram showing one example an overall process for creating a consistent sequence of updates. The operational flow diagram begins at step 2002 and flows directly to step 2004. The update manager 116, at step 2004, receives a cluster of updates. The update manager 116, at step 2006, eliminates redundancies in update operations. The update manager 116, at step 2008, generates a precedence graph for update operations. The update manager 116, at step 2010, constructs an update sequence as a topological ordering of nodes in the precedence graph. The update manager 116, at step 2012, then outputs a consistent sequence of updates. The control flow then exits at step 2014.

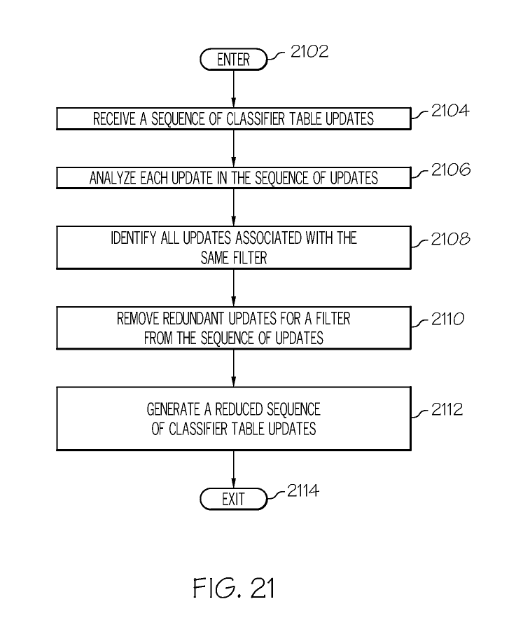

FIG. 21 is an operational flow diagram showing one example of a process for managing classifier tables. The operational flow diagram begins at step 2102 and flows directly to step 2104. The update manager 116, at step 2104, receives a sequence of classifier table updates, where each update in the sequence of updates is associated with a filter. The update manager 116, at step 2106, analyzes each update in the sequence of updates. The update manager 116, at step 2108, identifies, based on the analyzing, at least two updates (or all updates) associated with the same filter. The two updates result in an identical final state of the same filter.

The update manager 116, at step 2110, removes redundant updates for a filter from the sequence of updates. The update manager 116, at step 2112, generates, based on the removing, a reduced sequence of classifier table updates. This reduces sequence of classifier table updates comprises a set of classifier table updates from the sequence of classifier table update, where for each distinct filter in the reduced sequence of classifier table updates only one update is associated with a given final state of the distinct filter. The control flow then exits at step 2114.

In another embodiment, a sequence of classifier table updates is received. Each update in the sequence of updates is associated with a filter. Each update in the sequence of updates is analyzed. If multiple updates are received at the same time, then all updates associated with the same filter are identified based on analyzing the updates that were received at the same time. The updates on the same filter can be reduced to a single update resulting in an identical final state of the same filter. The other updates associated with the filter are removed from the sequence of updates. A reduced sequence of classifier updates is generated based on the other updates of filters with multiple updates being removed. The reduced sequence of classifier updates comprises a set of classifier table updates where for each distinct filter in the reduced sequence only one update is associated which specifies a given final state of the distinct filter. A reordered sequence of update operations is generated from the reduced sequence of update operations.

As can be seen from the above discussion, various embodiments perform incremental updates in classifier tables, when updates arrive together in clusters. By ordering the updates in a consistent manner, one or more embodiments ensure that the data packets are handled properly in terms of being forwarded to appropriate next hops, or being applied the proper action (e.g. accept/deny/drop). One or more embodiments also identify and remove the redundant updates from a given batch of updates. Any insert/delete/change operations that arrive in a cluster can be conveniently represented as a precedence graph. Every topological ordering of the vertices in the precedence graph gives a batch consistent sequence. Among all the batch consistent sequences it is desirable to have the one that leads to minimum growth of the rule table at the time of incorporating the updates. Therefore, one or more embodiments provide an efficient heuristic that builds a near optimal batch consistent sequence for practical datasets.

Information Processing System

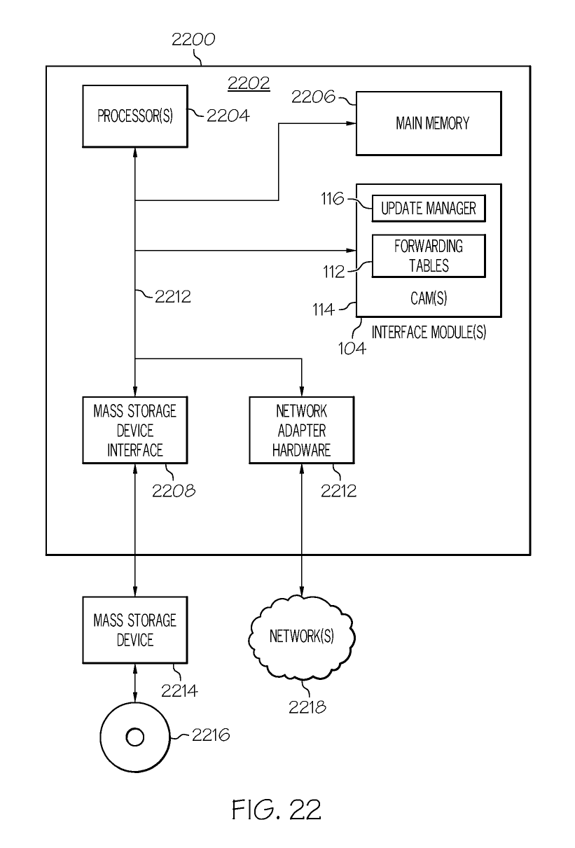

FIG. 22 is a block diagram illustrating an exemplary information processing system 2200, such as the network device 100 of FIG. 1, which can be utilized in one or more embodiments discussed above. The information processing system 2200 is based upon a suitably configured processing system adapted to implement one or more embodiments of the present invention. Similarly, any suitably configured processing system can be used as the information processing system 2200 by embodiments of the present invention.

The information processing system 2200 includes a computer 2202. The computer 2202 has a processor(s) 2204 that is connected to a main memory 2206, mass storage interface 2208, network adapter hardware 2210, and one or more interface modules 104. The interface module(s) 104 can comprise the forwarding tables 112, one or more CAMs 114, and the update manager 116, as discussed above. A system bus 2212 interconnects these system components.

Although illustrated as concurrently resident in the main memory 2206, it is clear that respective components of the main memory 2206 are not required to be completely resident in the main memory 2206 at all times or even at the same time. In this embodiment, the information processing system 2200 utilizes conventional virtual addressing mechanisms to allow programs to behave as if they have access to a large, single storage entity, referred to herein as a computer system memory, instead of access to multiple, smaller storage entities such as the main memory 2206 and data storage device 2216. The term “computer system memory” is used herein to generically refer to the entire virtual memory of the information processing system 2200.

The mass storage interface 2208 is used to connect mass storage devices, such as mass storage device 2214, to the information processing system 2200. One specific type of data storage device is an optical drive such as a CD/DVD drive, which may be used to store data to and read data from a computer readable medium or storage product such as (but not limited to) a CD/DVD 2216. Another type of data storage device is a data storage device configured to support, for example, NTFS type file system operations.

Although only one CPU 2204 is illustrated for computer 2202, computer systems with multiple CPUs can be used equally effectively. Embodiments of the present invention further incorporate interfaces that each includes separate, fully programmed microprocessors that are used to off-load processing from the CPU 2204. An operating system included in the main memory is a suitable multitasking operating system such as any of the Linux, UNIX, Windows, and Windows Server based operating systems. Embodiments of the present invention are able to use any other suitable operating system. Some embodiments of the present invention utilize architectures, such as an object oriented framework mechanism, that allows instructions of the components of operating system to be executed on any processor located within the information processing system 2200. The network adapter hardware 2210 is used to provide an interface to a network 2218. Embodiments of the present invention are able to be adapted to work with any data communications connections including present day analog and/or digital techniques and any future networking mechanism.

Although the exemplary embodiments of the present invention are described in the context of a fully functional computer system, those of ordinary skill in the art will appreciate that various embodiments are capable of being distributed as a program product via CD or DVD, CD-ROM, or other form of recordable media, or via any type of electronic transmission mechanism.

Non-Limiting Examples

The present invention can be realized in hardware, software, or a combination of hardware and software. A system according to one embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The kernel associate memory can be used as the underlying hardware and software infrastructure to create content addressable memories where, just like human memory, the number of items stored can grow even when the physical hardware resources remain of the same size.

What is claimed is:

1. A method for managing classifier tables, the method comprising:
receiving a sequence of classifier table updates, wherein each update in the sequence of updates is associated with a filter;
analyzing each update in the sequence of updates;
identifying, based on the analyzing, at least two updates associated with the same filter, wherein the two updates result in an identical final state of the same filter;
removing at least one of the two updates from the sequence of updates; and
generating, based on the removing, a reduced sequence of classifier table updates comprising a set of classifier table updates from the sequence of classifier table update where for each distinct filter in the reduced sequence of classifier table updates only one update is associated with a given final state of the distinct filter.

2. The method of claim 1, wherein the set of classifier table updates are a set of Internet router table updates.

3. The method of claim 1, wherein the filter is a prefix.

4. The method of claim 1, further comprising:
generating a reordered sequence (S) of classifier table updates using the reduced sequence (U) of classifier table updates, wherein the reordered sequence of classifier table updates S is batch consistent as defined by:
Tᵣ(U)=Tₘ(S)̂∀i∀f[action(f,Tᵢ(S)]∈{action(f,T₀),action(f,Tᵣ(U))}
where U=u₁, . . . , uᵣ and is an original update sequence, each uᵢ being an insert, delete, or change operation,
where Tᵣ is an intermediate state after update uᵣ has been performed,
where S=s₁, . . . , sₘ and is a second update sequence, each s, being an insert, delete, or change operation,
wherein Tₘ is a final state after update sₘ has been performed,
wherein T₀ is a classifier table and Tᵢ(U) is the state of this classifier table after the operations uᵢ, . . . , uᵢ have been performed, in this order, on T₀,
where action(f ,R) indicates that an action corresponding to a highest priority matching rule for filter f is classifier R.

5. The method of claim 1, further comprising:
generating a reordered sequence (S) of classifier table updates using the reduced sequence (U) of classifier table updates, wherein the reordered sequence of classifier table updates is incremental consistent as defined by:
Tᵣ(U)=Tₘ(S)̂∀i∀f[action(f,Tᵢ(S)]∈{action(f,T₀), . . . , action(f,Tᵣ(U))}
where U=u₁, . . . , uᵣ and is the original update sequence, each uᵢ being an insert, delete, or change operation,
where Tᵣ is an intermediate state after update uᵣ has been performed,
where S=s₁, . . . , sₘ and is a second update sequence, each s, being an insert, delete, or change operation,
wherein Tₘ is a final state after update sₘ has been performed,
wherein T₀ is a classifier table and Tᵢ (U) is the state of this classifier table after the operations u₁, . . . , uᵢ have been performed, in this order, on T₀,
where action(f ,R) indicates that an action corresponding to a highest priority matching rule for filter f is classifier R.

6. The method of claim 1, further comprising:
generating a reordered batch consistent sequence of classifier tables updates using the reduced sequence of classifier table updates, wherein the generating comprises:
placing a first set of updates of a first type in a first portion of the reduced sequence in decreasing order of filter length;
placing a second set of updates of a second type in a second portion that is after the first portion of the reduced sequence; and
placing a third set of updates of a third type in a third portion that is after the second portion of the reduced sequence in increasing order of filter length.

7. The method of claim 6, wherein the first type is an insert update, wherein the second type is a change update, and wherein the third type is a delete update.

8. The method of claim 1, wherein the reduced sequence of classifier table updates comprises a minimal set of classifier table updates that satisfies a goal of the sequence of classifier table updates that was received.

9. The method of claim 1, further comprising:
performing the reduced sequence of classifier table updates in a batch consistent order that minimizes a maximum size of an intermediate classifier table.

10. The method of claim 9, wherein the performing further comprises:
constructing an m vertex diagraph G(V) from V=v₁, . . . , vₘ, wherein vertex i of G represents an update operation vᵢ,
where (Fᵢ, Aᵢ) is a rule associated with update vᵢ, 1≦i≦m;
wherein a directed edge exists between vertices i and j if and only if at least:
all fields in tuples Fᵢ and Fⱼ overlap as defined by Fᵢ∩Fⱼ=S, S≠Ø, where S is a tuple built from fields representing overlapping regions of Fᵢ and Fⱼ, and
there is no rule (Fₖ, Aₖ) such that Fₖ∩S≠Ø and priority of (Fₖ, Aₖ) lies between those of rules (Fᵢ, Aᵢ) and (Fⱼ, Aⱼ).

11. The method of claim 10, wherein the directed edge exists between vertices i and j further if and only one of the following relationships between vᵢ and vⱼ , hold:
vᵢ and vⱼ are inserts [symbol] (i, j)∈E(G), where E(G) is the set of directed edges of G;
vᵢ is an insert and vⱼ is a delete [symbol] (i, j)∈E(G);
vᵢ and vⱼ are deletes [symbol] (j,i)∈E(G);
vᵢ is a delete and vⱼ is an insert [symbol] (j,i)∈E(G);
vᵢ is an insert and vⱼ is a change [symbol] (i, j)∈E(G); and
vᵢ is a delete and vⱼ is a change [symbol] (j,i)∈E(G).

12. The method of claim 10, further comprising:
assigning a weight to vertex i of G(V) based on an update type associated with vᵢ.

13. The method of claim 12, wherein a permutation of the reduced update set V is batch consistent if and only if it corresponds to a topological ordering of the vertices of G(V).

14. An information processing system for managing classifier tables, the information processing system comprising:
a memory;
a processor communicatively coupled to the memory; and
an update manager communicatively coupled to the memory and the processor, wherein the update manager is configured to perform a method comprising:
receiving a sequence of classifier table updates, wherein each update in the sequence of updates is associated with a filter;
analyzing each update in the sequence of updates;
identifying, based on the analyzing, at least two updates associated with the same filter, wherein the two updates result in an identical final state of the same filter;
removing at least one of the two updates from the sequence of updates; and
generating, based on the removing, a reduced sequence of classifier table updates comprising a set of classifier table updates from the sequence of classifier table update where for each distinct filter in the reduced sequence of classifier table updates only one update is associated with a given final state of the distinct filter.

15. The information processing system of claim 14, wherein the method further comprises:
generating a reordered sequence (S) of classifier table updates using the reduced sequence (U) of classifier table updates, wherein the reordered sequence of classifier table updates S is batch consistent as defined by:
Tᵣ(U)=Tₘ(S)̂∀i∀f[action(f,Tᵢ(S)]∈{action(f,T₀),action(f,Tᵣ(U))}
where U=u₁, . . . , uᵣ and is an original update sequence, each uᵢ being an insert, delete, or change operation,
where Tᵣ is an intermediate state after update a, has been performed,
where S=s₁, . . . , sₘ and is a second update sequence, each s, being an insert, delete, or change operation,
wherein Tₘ is a final state after update sₘ has been performed,
wherein T₀ is a classifier table and Tᵢ(U) is the state of this classifier table after the operations u₁, . . . , uᵢ have been performed, in this order, on T₀,
where action(f , R) indicates that an action corresponding to a highest priority matching rule for filter f is classifier R.

16. The information processing system of claim 14, wherein the method further comprises:
generating a reordered sequence (S) of classifier table updates using the reduced sequence (U) of classifier table updates, wherein the reordered sequence of classifier table updates is incremental consistent as defined by:
Tᵣ(U)=Tₘ(S)̂∀i∀f[action(f,Tᵢ(S)]∈{action(f,T₀), . . . , action(f,Tᵣ(U))}
where U=u₁, . . . , uᵣ and is the original update sequence, each uᵢ being an insert, delete, or change operation,
where Tᵣ is an intermediate state after update uᵣ has been performed,
where S=s₁, . . . , sₘ and is a second update sequence, each s, being an insert, delete, or change operation,
wherein Tₘ is a final state after update sₘ has been performed,
wherein T₀ is a classifier table and Tᵢ(U) is the state of this classifier table after the operations u₁, . . . , uᵢ have been performed, in this order, on T₀,
where action(f,R) indicates that an action corresponding to a highest priority matching rule for filter f is classifier R.

17. The information processing system of claim 14, wherein the method further comprises:
generating a reordered sequence of classifier tables updates using the reduced sequence of classifier table updates, wherein the generating comprises:
placing a first set of updates of a first type in a first portion of the reduced sequence in decreasing order of filter length;
placing a second set of updates of a second type in a second portion that is after the first portion of the reduced sequence; and
placing a third set of updates of a third type in a third portion that is after the second portion of the reduced sequence in increasing order of filter length.

18. A computer program product for managing classifier tables, the computer program product comprising computer readable storage medium having computer readable program code embodied therewith, the computer readable program code comprising computer readable program code configured to perform a method comprising:
receiving a sequence of classifier table updates, wherein each update in the sequence of updates is associated with a filter;
analyzing each update in the sequence of updates;
identifying, based on the analyzing, at least two updates associated with the same filter, wherein the two updates result in an identical final state of the same filter;
removing at least one of the two updates from the sequence of updates; and
generating, based on the removing, a reduced sequence of classifier table updates comprising a set of classifier table updates from the sequence of classifier table update where for each distinct filter in the reduced sequence of classifier table updates only one update is associated with a given final state of the distinct filter.

19. The computer program product of claim 18, wherein the method further comprises:
generating a reordered sequence (S) of classifier table updates using the reduced sequence (U) of classifier table updates, wherein the reordered sequence of classifier table updates S is batch consistent as defined by:
Tᵣ(U)=Tₘ(S)̂∀i∀f[action(f,Tᵢ(S)]∈{action(f,T₀),action(f,Tᵣ(U))}
where U=u₁, . . . , uᵣ and is an original update sequence, each uᵢ being an insert, delete, or change operation,
where Tᵣ is an intermediate state after update uᵣ has been performed,
where S=s₁, . . . , sₘ and is a second update sequence, each s, being an insert, delete, or change operation,
wherein Tₘ is a final state after update sₘ has been performed,
wherein T₀ is a classifier table and Tᵢ(U) is the state of this classifier table after the operations u₁, . . . , uᵢ have been performed, in this order, on T₀,
where action(f,R) indicates that an action corresponding to a highest priority matching rule for filter f is classifier R.

20. The computer program product of claim 18, wherein the method further comprises:
generating a reordered sequence (S) of classifier table updates using the reduced sequence (U) of classifier table updates, wherein the reordered sequence of classifier table updates is incremental consistent as defined by:
Tᵣ(U)=Tₘ(S)̂∀i∀f[action(f,Tᵢ(S)]∈{action(f,T₀), . . . , action(f,Tᵣ(U))}
where U=u₁, . . . , uᵣ and is the original update sequence, each uᵢ being an insert, delete, or change operation,
where Tᵣ is an intermediate state after update uᵢ has been performed,
where S=s₁, . . . , sₘ and is a second update sequence, each s, being an insert, delete, or change operation,
wherein Tₘ is a final state after update sₘ has been performed,
wherein T₀ is a classifier table and Tᵢ(U) is the state of this classifier table after the operations u₁, . . . , uᵢ have been performed, in this order, on T₀,
where action(f,R) indicates that an action corresponding to a highest priority matching rule for filter f is classifier R.
